(19) United States
(12) Patent Application Publication
(10) Pub. No.: US 2026/0243390 A1
(43) Pub. Date: Aug. 20, 2026

(54) Support Bracket

(71) Applicant: Barrski Products, Inc., Lowell, MA (US)

(72) Inventors: Stephen John Winalski, Lowell, MA (US); James Patrick Barry, West Bridgewater, MA (US)

(21) Appl. No.: 19/347,480

(22) Filed: Oct. 1, 2025

Related U.S. Application Data
(63) Continuation of application No. 29/990,317, filed on Feb. 20, 2025.

(51) Int. Cl. F16M 13/02; F04B 49/10

(52) U.S. Cl. CPC F16M 13/02; F04B 49/10

(57) ABSTRACT

The present disclosure provides for an apparatus for a support bracket for a pump, such as a condensate pump. To overcome issues with floor-mounted pumps, such as trip hazards and water damage from leaks, the invention offers an elevated and contained mounting solution. The bracket includes a vertical wall support portion with openings for mounting to a surface. A horizontal pump support portion extends from the vertical portion to receive a pump. A continuous raised perimeter wall on the horizontal portion forms an integrated basin. This basin is configured to collect and contain fluid, such as from an overflow or leak, thereby protecting the surrounding area.

### CROSS-REFERENCE TO RELATED APPLICATION

This application claims priority to and the full benefit of U.S. Design patent application Ser. No. 29/990,317 (filed Feb. 20, 2025, and titled “Support”), the entire contents of which are incorporated in this application by reference.

### BACKGROUND

Traditionally, condensate pumps, which are used to remove water produced by air conditioning units, high-efficiency furnaces, and dehumidifiers, are placed directly on the floor or ground adjacent to the appliance they serve. This installation method is common due to its simplicity, as it requires no additional hardware or complex mounting procedures. The pump simply rests on the available floor space.

The problem is that this conventional placement presents several significant disadvantages. Placing a condensate pump directly on the floor exposes it to potential damage from being accidentally kicked, bumped by cleaning equipment like vacuums, or otherwise disturbed. Such placement is also a trip hazard for the homeowner or the technicians. Furthermore, condensate pumps are prone to leakage or overflow, either from a malfunction, a blockage in the discharge line, or during routine maintenance. When such a leak occurs with a floor-mounted pump, the water spills directly onto the surrounding surface, which can cause significant water damage to flooring, subflooring, and nearby walls. This creates a costly repair situation, a potential slip hazard, and an environment conducive to the growth of mold and mildew. Therefore, a need exists for a solution that elevates the condensate pump and contains any potential leakage.

In addition, traditionally, the support of pipes and conduits within building structures, such as residential or commercial framing, has been accomplished using rudimentary hardware. These conventional support mechanisms often consist of simple metal straps, such as galvanized steel or copper hangers, which are manually bent around a pipe and fastened to a support beam or joist with nails or screws. In other cases, plumbers or electricians may fabricate supports on-site using scrap wood, cutting a notch into a block to cradle the pipe. Another common method involves using basic metal J-hooks that are screwed into the wooden structure.

The problem is that these traditional methods are fraught with inefficiencies and potential long-term issues. The installation of metal straps and custom-cut wood blocks is labor-intensive and lacks uniformity, leading to inconsistent spacing and support along the length of a pipe run. Metal supports are susceptible to corrosion, particularly in damp environments like basements and crawlspaces. Furthermore, direct contact between dissimilar metals (e.g., a copper pipe and a galvanized steel strap) can induce galvanic corrosion, weakening both the pipe and the support over time. These metal-on-metal contact points are also a primary source for the transmission of unwanted vibration and acoustic noise. Finally, the sharp edges of metal straps or the rough texture of wooden blocks can abrade and damage the exterior of pipes, especially modern plastic pipes such as PEX or PVC.

### SUMMARY OF THE DISCLOSURE

What is needed is support structures for HVAC equipment and piping. An embodiment of a bracket for supporting a pump includes a vertical wall support portion and a horizontal pump support portion. The vertical wall support portion includes at least one opening that is configured for mounting the bracket to a vertical surface. Extending perpendicularly from this vertical portion is the horizontal pump support portion, which is configured to receive a pump, such as a condensate pump. A continuous raised perimeter wall extends upwardly from the top surface of the horizontal pump support portion, and in some embodiments, this wall also extends along the vertical wall support portion. The raised perimeter wall and the horizontal pump support portion together define a basin configured to collect and contain fluid. In one configuration, this continuous raised perimeter wall creates an incline on the edge of the horizontal pump support portion that is farthest from the vertical wall. The wall also creates a channel on the underside of the bracket, which is reinforced to increase the weight holding capacity of the bracket to, for example, 25 lbs.

In another embodiment, a bracket for a condensate pump includes a unitary body that has a substantially L-shaped profile. This body is composed of a horizontal shelf with a top surface for receiving the condensate pump and a vertical plate that extends upwardly from a rear edge of the horizontal shelf. The vertical plate includes a plurality of holes for fastening the apparatus to a structure. The top surface of the horizontal shelf is bounded on at least its front edge and two side edges by an integral, upwardly-projecting wall. This wall thereby forms a basin on the top surface for the purpose of pooling liquid.

A further embodiment describes a bracket for a condensate pump that includes a unitary body with a substantially L-shaped profile. The body features a horizontal shelf with a top surface for receiving the condensate pump, and this shelf has a front edge and two horizontal side edges. A vertical plate extends upwardly from the rear edge of the horizontal shelf, and this plate includes a plurality of holes for fastening the apparatus to a structure, as well as a top edge and two vertical side edges. A continuous raised perimeter wall is positioned along the edges of both the horizontal shelf and the vertical plate. This continuous wall is perpendicular to the horizontal shelf along the front and horizontal edges, and it is also perpendicular to the vertical plate along the top and vertical edges. Functionally, the continuous raised perimeter wall forms a basin for pooling liquid on the top surface, and it also creates a reinforced channel on the underside of the unitary body to increase the carrying capacity of the bracket.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates a bracket for a condensate pump, according to some embodiments of the present disclosure.

FIG. 2 illustrates a front view of the bracket with a condensate pump according to some embodiments of the present disclosure.

FIG. 3 illustrates a front view of the bracket with an alternative condensate pump, according to some embodiments of the present disclosure.

FIG. 4 illustrates a side view of the bracket for a condensate pump according to some embodiments of the present disclosure.

FIG. 5 illustrates a back view of the bracket for a condensate pump, according to some embodiments of the present disclosure.

FIG. 6 illustrates a perspective view of a support saddle for a pipe, according to some embodiments of the present disclosure.

FIG. 7 illustrates a side view of a support saddle for a pipe, according to some embodiments of the present disclosure.

FIG. 8 illustrates a bottom view of a support saddle for a pipe, according to some embodiments of the present disclosure.

FIG. 9 illustrates a side view of a support saddle for a pipe, according to some embodiments of the present disclosure.

FIG. 10 illustrates a bottom perspective view of a support saddle for a pipe, according to some embodiments of the present disclosure.

FIG. 11 illustrates a top view of a support saddle for a pipe, according to some embodiments of the present disclosure.

FIG. 12 illustrates a front view of a support saddle for a pipe, according to some embodiments of the present disclosure.

FIG. 13 illustrates a perspective view of the support saddle for a pipe, according to some embodiments of the present disclosure.

FIG. 14 illustrates a perspective view of a plurality of support saddles, according to some embodiments of the present disclosure.

The Figures are not necessarily drawn to scale, as their dimensions can be varied considerably without departing from the scope of the present disclosure.

### DETAILED DESCRIPTION

The present disclosure provides generally for brackets for HVAC related equipment and piping.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

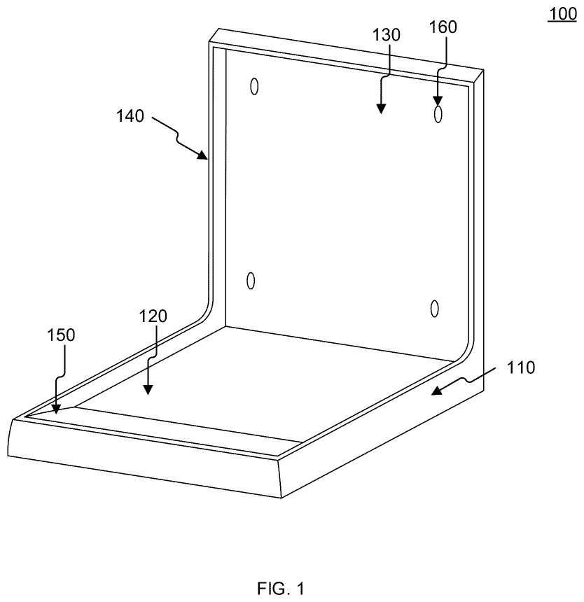

Referring now to FIG. 1, a bracket 100 for a condensate pump (not shown), according to some embodiments of the present disclosure, is illustrated. The bracket 100 includes a unitary body 110 in a substantially L-shaped profile. The unitary body includes a horizontal shelf 120 and a vertical plate 130.

The horizontal shelf 120 is configured to receive a condensate pump. In some embodiments, the horizontal shelf 120 may include one or more openings to allow a condensate pump to be attached to the horizontal shelf. In some embodiments, the attachment mechanism, such as screws or bolts, may include a waterproof seal. In some embodiments, the horizontal shelf 120 may be manufactured with a polished or textured surface. The textured surface may be preferred when there is a need or desire to increase the friction between the horizontal shelf 120 and the compensate pump.

The vertical plate 130 extends upward from the horizontal shelf 120 and perpendicular to the horizontal shelf 120. The vertical plate 130 includes four openings 160. The openings 160 are configured to receive attachment mechanisms to removably connect the bracket 100 to a vertical surface, such as a wall. In some embodiments, the attachment mechanisms (not shown) may be screws, nails, rivets, bolts, cap screws, or other threaded and non-threaded mechanical fasteners, high strength adhesives and bonding agents. In some embodiments, the number of openings may be adjusted to increase the strength of attachment to the vertical surface. In some embodiments, the openings 160 may be omitted from the vertical plate 130. In such embodiments, a different attachment mechanism, such as a cord and hook mechanism (as commonly used in hanging picture frames) may be used so long as the attachment mechanism is capable of supporting the bracket and a condensate pump during use.

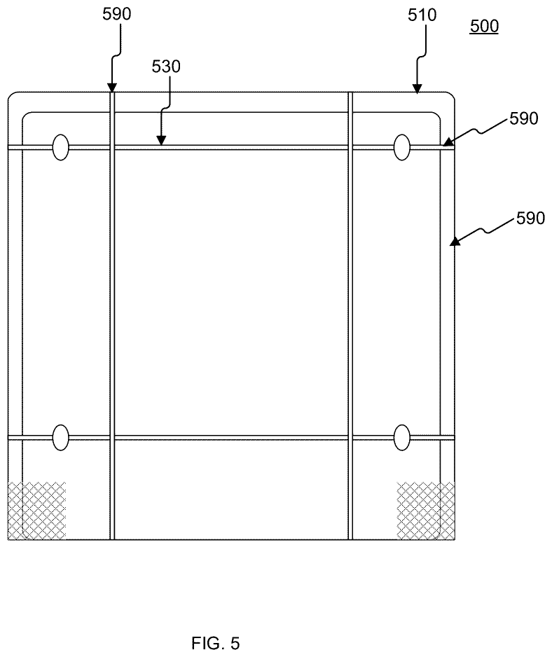

The periphery of the unitary body 110 includes a continuous raised perimeter wall 140. The perimeter wall 140 surrounds the edges of the unitary body 110. The perimeter wall 140 extends perpendicular to the horizontal shelf 120 and the vertical plate 130 along their respective periphery. As described further in relation to FIG. 5, the perimeter wall 140 creates a channel on the back or underside of the unitary body 110. The channel may include ribs to increase strength and stiffness of the horizontal shelf 120 and the vertical plate 130. The backsides of the horizontal shelf 120 and the vertical plate 130 may also include ribs or cross beams to similarly increase the structural integrity and the carrying capacity of the bracket.

The perimeter wall 140 is designed to form an angled plane 150 from the top portion of the perimeter wall 140 down to the top surface of the horizontal shelf 120. The section of the perimeter wall 140 that surrounds the horizontal shelf 120 and the vertical plate 130 form an enclosed basin. The basin is configured to receive and hold liquid, such as water from condensate, that may overflow or leak from the condensate pump.

In some embodiments, the horizontal shelf 120 and the vertical plate 130 may be constructed as two separate pieces with the perimeter wall 140 split among the two separately constructed pieces. The horizontal shelf 120 and the vertical plate 130 may be configured to be mechanically attached to one another and form a waterproof seal along the connecting edge.

In some embodiments, the unitary body 110 of the bracket 100 may be constructed from a durable and water-resistant plastic material. A potential method of manufacturing is injection molding, which allows the entire unitary body 110 including the horizontal shelf 120, the vertical plate 130, the continuous raised perimeter wall 140, and the plurality of ribs 590 to be formed in a single, efficient process. Suitable materials for construction include, but are not limited to, common thermoplastic polymers such as polyamide (PA), Acrylonitrile Butadiene Styrene (ABS), Polypropylene (PP), Polyvinyl Chloride (PVC), or High-Density Polyethylene (HDPE). The choice of material may be based on desired characteristics such as rigidity, impact resistance, durability, fire retardancy, UV resistance, and cost.

In some embodiments, the basin formed by the horizontal shelf 120 and the perimeter wall 140 may further include an integrated drain port. The drain port is configured to allow for the controlled removal of any liquid collected within the basin. In some embodiments, the drain port may comprise a threaded aperture, configured to accept a standard hose fitting, thereby allowing collected liquid to be routed to a suitable drain. The port may be furnished with a removable, water-tight cap or plug for instance where liquid containment, rather than immediate drainage, is desired.

In some embodiments, the unitary body 110 may be replaced with an adjustable assembly comprising a horizontal shelf member and a vertical plate member connected by a pivot mechanism. The pivot mechanism may be configured to allow the angular relationship between the horizontal shelf and the vertical plate to be adjusted and securely locked in a desired position. The locking feature may include, for example, a serrated locking interface engaged by a tightening bolt, or a friction clamp. This configuration permits the bracket to be securely mounted to non-vertical surfaces, such as slanted walls commonly found in attics or basements.

In some embodiments, the bracket 100 may incorporate an electronic liquid level detection system. The system may include one or more conductive probes or a float switch integrated into the interior surface of the basin formed by the horizontal shelf 120. The system may activate an alarm when it detects liquid at a predetermined level. The alarm may be an audible alarm, such as a piezoelectric buzzer, or a visual alarm, such as a light-emitting diode (LED) mounted on an exterior surface of the bracket. Power for the detection system may be provided by a self-contained battery. In some embodiments, the system may further include an output relay configured to interrupt power to the condensate pump or the associated HVAC equipment, thereby preventing further overflow.

In some embodiments, the vertical plate 130 may be configured with an attachment mechanism (not shown). Rather than, or in addition to, the openings 160, the vertical plate 130 may include one or more high-strength permanent magnets. The magnets may be encapsulated within the plastic material of the vertical plate 130 during the manufacturing process to protect them from moisture and corrosion. The magnets may allow the bracket 100 to attach to ferromagnetic surfaces, such as the metallic housing of a furnace or air handler, without requiring the use of tools or the creation of permanent holes in the mounting surface.

In some embodiments, a bubble level may be integrated into the vertical plate 130 or the horizontal shelf 120 visible from the front side of the unitary body 110. The bubble level may be single or dual axis bubble level viewable by a user while installing the bracket 100 in a proper orientation.

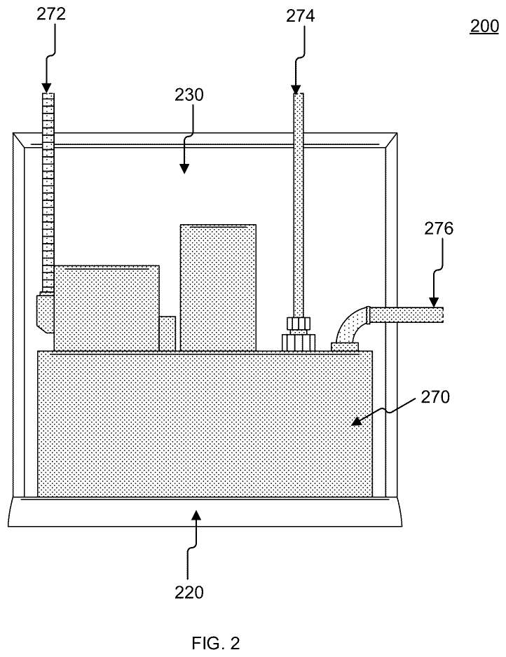

Referring now to FIG. 2, a front view of the bracket with a condensate pump, according to some embodiments of the present disclosure, is illustrated during use. As shown in FIG. 2, the bracket 200 includes a horizontal shelf 220 and a vertical plate 230. The horizontal shelf 220 is loaded with a condensate pump 270. The condensate pump 270 may be any type or brand. The condensate pump 270 is placed on the basin of the horizontal shelf 220. The condensate pump 270 may also be connected to power 272, a condensate outlet 274, and an inlet 276.

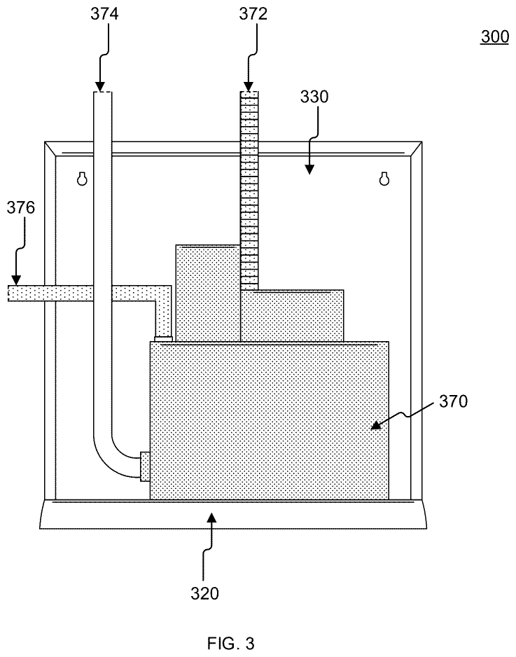

Referring now to FIG. 3, a front view of the bracket with a condensate pump, according to some embodiments of the present disclosure, is illustrated during use. As shown in FIG. 3, the bracket 300 includes a horizontal shelf 320 and a vertical plate 330. The horizontal shelf 320 is loaded with a condensate pump 370. The condensate pump 370 is placed on the basin of the horizontal shelf 320. The condensate pump 370 may also be connected to power 372, a condensate outlet 374, and an inlet 376.

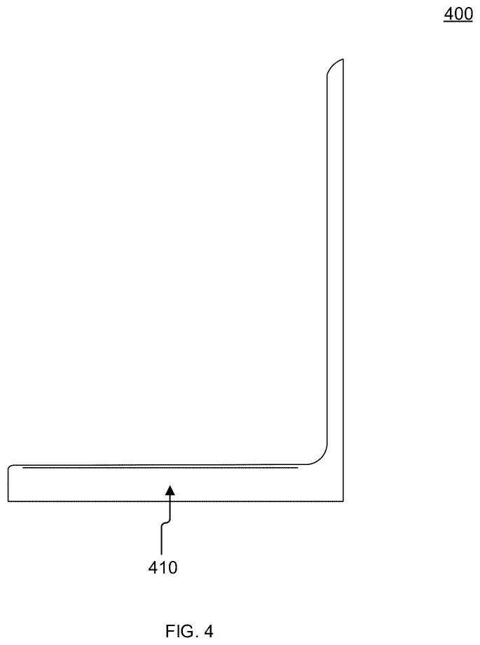

Referring now to FIG. 4, a side view of the bracket 400 for a condensate pump (not shown), according to some embodiments of the present disclosure, is illustrated. In some embodiments the edges and the corners of the unitary body 410 may be manufactured with sharp or rounded edges.

Referring now to FIG. 5, a back view of the bracket 500 for a condensate pump, according to some embodiments of the present disclosure, is illustrated. The bracket 500 includes a unitary body 510. The unitary body 510 includes the vertical plate 530. The unitary body 510 also includes a channel 590 created by the peripheral wall, which was illustrated in relation to FIG. 1. The unitary body 510 includes a plurality of ribs 590 positioned within the channel 590. The plurality of ribs 590 increase the structural integrity and the weight bearing capacity of the bracket 500.

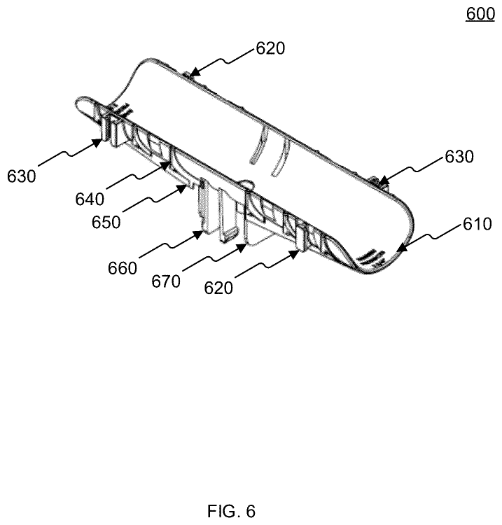

Referring now to FIG. 6, a perspective view of a support saddle 600 for a pipe, according to some embodiments of the present disclosure, is illustrated. In some embodiments, the support saddle 600 may be constructed from a durable and water-resistant plastic material. A potential method of manufacturing is injection molding, which allows the entire body to be formed in a single, efficient process. This method assists in manufacturing consistency and structural integrity. Suitable materials for construction include, but are not limited to, common thermoplastic polymers such as polyamide (PA), Acrylonitrile Butadiene Styrene (ABS), Polypropylene (PP), Polyvinyl Chloride (PVC), or High-Density Polyethylene (HDPE). The choice of material may be based on desired characteristics such as rigidity, impact resistance, durability, fire retardancy, UV resistance, and cost.

The choice of material may also be selected based on the intended use of or the location of use of the support saddle 600. For example, when intended to be used for hot water pipes, the support saddle 600 may be manufactured from a heat-resistant material. In another example, when intended to be used for tubes containing electrical wiring, the support saddle 600 may be manufactured from a non-conductive material. Similarly, if the support saddle 600 is intended to be used in a corrosive environment, a more corrosion resistant material may be chosen.

The support saddle 600 includes a circular support member 610 with a hollow section configured to receive a pipe. The circular support member 610 may include markings to indicate direction, material type, size, or other information.

The underside of the support saddle 600 may include a plurality of male attachment members 620 and a plurality of female attachment members 630. The male attachment members 620 and the female attachment members 630 are located near the top section of the circular support member 610. Each attachment member is also located on an opposing side of the circular support member 610 from a corresponding attachment member. This configuration allows multiple support saddles 600 to be installed next to each other. The female attachment member 630 is configured the receive the male attachment member 620 and restrict the lateral movement of a second support saddle 600 away from a first support saddle 600.

The underside of the support saddle 600 also includes a plurality of ribs 640 positioned at an angle to the edges of the circular support member 610. The underside of the support saddle 600 also includes a plurality of support ribs 650 running parallel to and substantially in the middle of the circular support member 610. The details of the ribs 640 and the support ribs 650 are described in additional detail below.

The support saddle 600 is configured to engage with one or more slots of a strut channel using a cantilever snap-fit fastener. The support saddle 600 includes a male component 660 of the snap-fit fastener. The male component 660 is a cantilever beam, which is a projecting feature that deflects during assembly. The engagement face of the protrusion interacts with the female component to create the locking mechanism. The undercut provides the locking mechanism, preventing the male and female parts from separating easily. The corresponding female component (not shown) may be part of a strut channel, or other support structures with suitable slots, and includes a recess designed to receive the male component. The support saddle 600 may be installed on top of a strut channel where the C shape opening of the strut channel receives the support saddle.

In some embodiments, the male component 660 may be replaced with a platform that serves as a female component of the snap-fit fastener configured to engage a male snap-fit component of a support beam, or an attachment to a strut channel.

In some embodiments, the cantilever snap-fit fastener may be replaced entirely with a platform or other suitable structure to allow the support saddle 600 to connect to a strut channel using other mechanical or chemical engagement mechanism, such as screws, nails, rivets, bolts, cap screws, or other threaded and non-threaded mechanical fasteners, high strength adhesives and bonding agents.

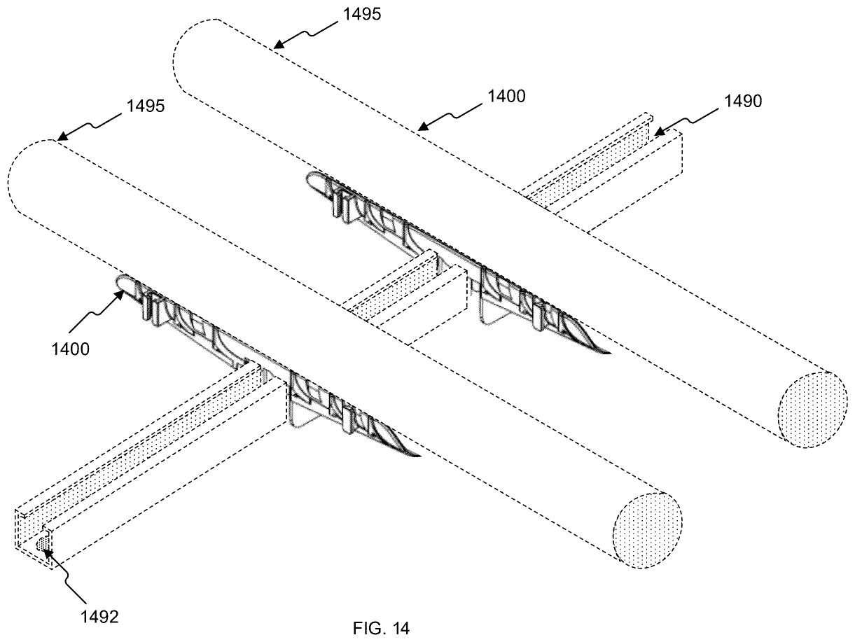

Underside of the support saddle 600 also includes a plurality of guiding protrusions 670. The guiding protrusions 670 are placed near the male components 660. As described further in relation to FIG. 14, the guiding protrusions are configured to line up on the outside of a strut channel when the user is positioning the support saddle to be inserted into the strut channel.

In some embodiments, the support saddle may be specifically configured for vibration and acoustic dampening. The interior surface of the circular support member may be lined with an elastomeric material. This liner may be co-molded or over-molded with the primary rigid plastic body of the support saddle. Suitable elastomeric materials include, but are not limited to, Thermoplastic Elastomers (TPE), silicone, or synthetic rubbers. The soft, pliable liner serves to isolate the pipe from the rigid bracket and the building structure to which the bracket is attached. This configuration is particularly advantageous in applications involving fluid transport systems where pump-induced vibrations are prevalent. The elastomeric liner absorbs mechanical vibrations and dampens acoustic noise, preventing their transmission through the strut channel and into the surrounding environment, thereby leading to a quieter and more stable installation.

In some embodiments, the circular support member 610 may be manufactured at a less than 90-degree angle (non-perpendicular) to the plurality of male components 660 to provide for multi-axis or angled pipe installation. Such implementations may be used to support pipes that are installed non-horizontally. In some aspects, the angle between the male components 660 and the circular support member 610 may be adjustable.

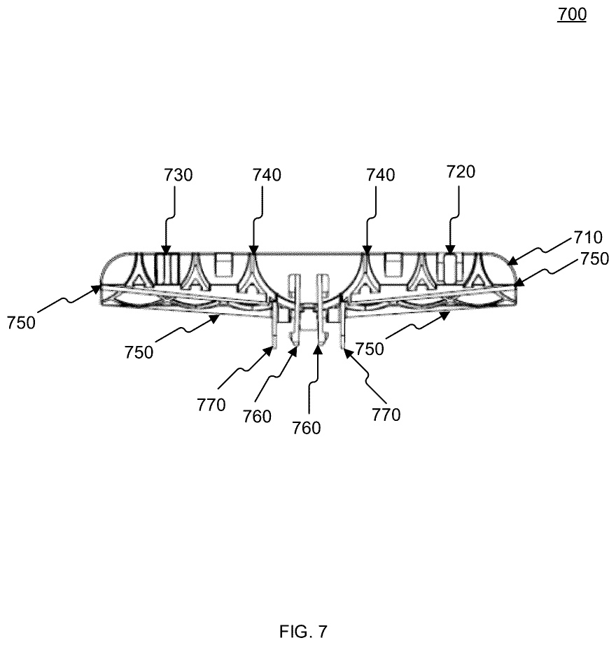

Referring now to FIG. 7, a side view of a support saddle 700 for a pipe, according to some embodiments of the present disclosure, is illustrated. The side view of the support saddle 700 illustrates the underside of the circular support member 710, the male attachment member 720, the female attachment member 730, the plurality of ribs 740, the plurality of support ribs 750, the plurality of male components 760 operating as cantilever beams for a snap-fit fastener, and the plurality of guiding protrusions 770.

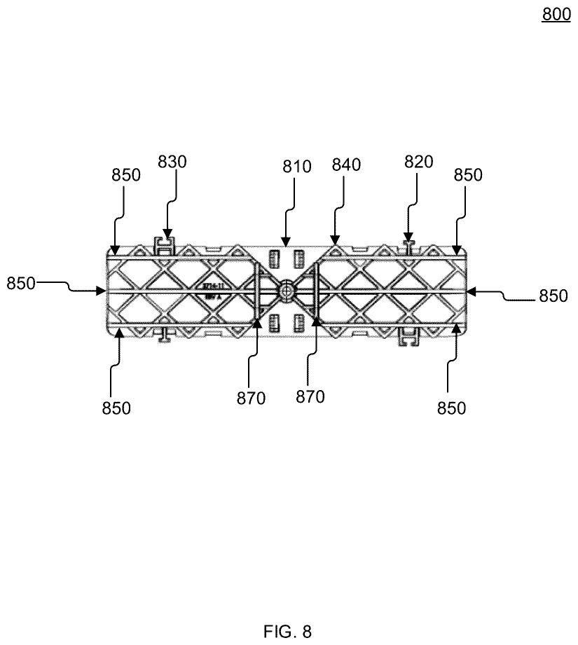

Referring now to FIG. 8, a bottom view of a support saddle 800 for a pipe, according to some embodiments of the present disclosure, is illustrated. The male component 820 forms a “T” shape. The female component 830 is configured to have a “T” shape opening.

The plurality of support ribs 850 run substantially parallel to the circular support member 810 from the edge of the circular support member 810 to the guiding protrusion 870. In some embodiments the number of support ribs 850 may be adjusted based on the desired horizontal support strength of the circular support member 810.

The plurality of ribs 840 form a diamond shape pattern on the underside of the support saddle 800. The arrangement of the plurality of ribs 840 is desirable to increase the strength and stiffness of the support saddle 800 without requiring a change in material.

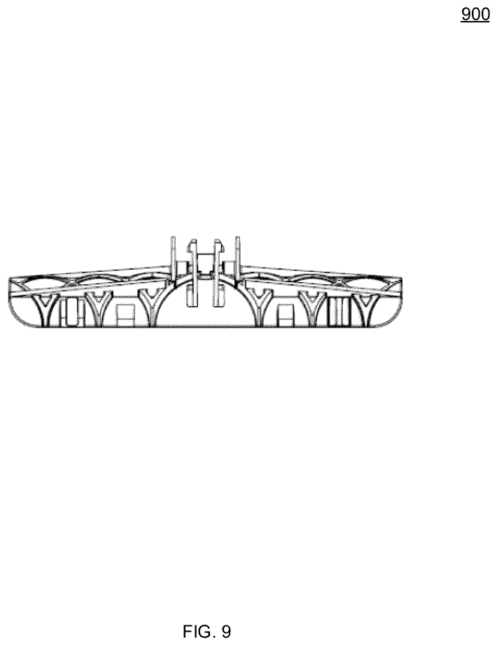

Referring now to FIG. 9, another side view of a support saddle 900 for a pipe, according to some embodiments of the present disclosure, is illustrated.

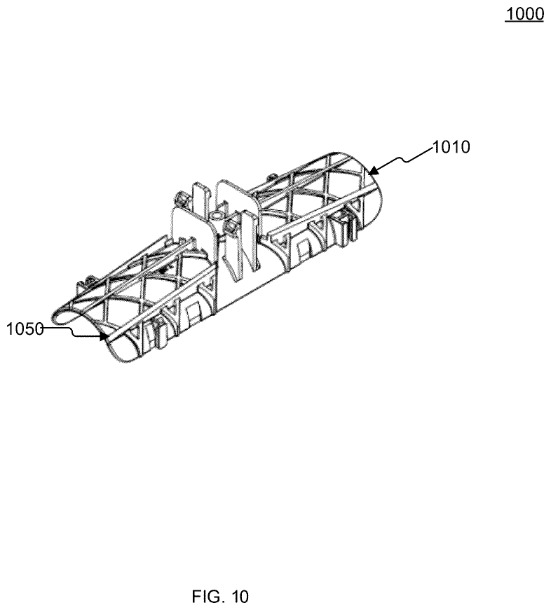

Referring now to FIG. 10, a bottom perspective view of a support saddle 1000 for a pipe, according to some embodiments of the present disclosure, is illustrated. The support ribs 1050 are configured as an incline plane at a predetermined angle from a plan tangential to the bottom surface of the circular support member 1010. The support ribs 1050 are thinnest at the edges of the circular support member 1010, gradually increasing in thickness until it is thickest near the middle of the circular support member 1010.

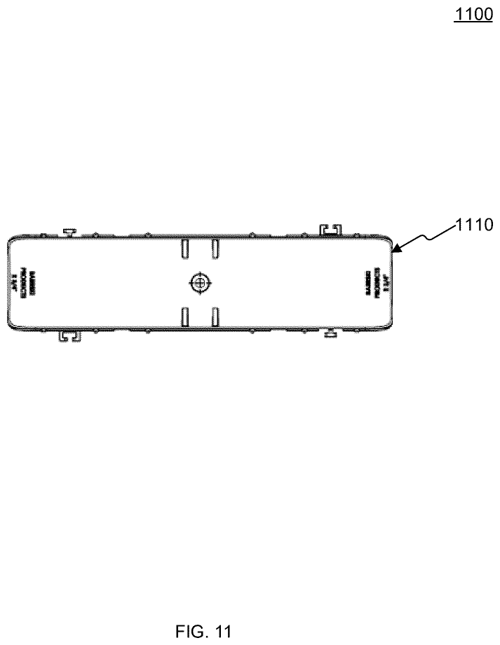

Referring now to FIG. 11, a top view of a support saddle 1100 for a pipe, according to some embodiments of the present disclosure, is illustrated. The circular support member 1110 may include a variety of markings such as origin, plastic type, use type, size, or direction. The circular support member 1110 also includes a marking to indicate the center of the support saddle 1100 to aid the user in aligning the support saddle 1100 to a strut channel (not shown).

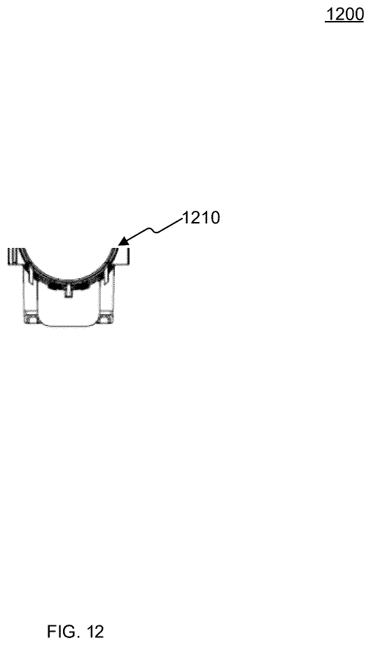

Referring now to FIG. 12, a front view of a support saddle 1200 for a pipe, according to some embodiments of the present disclosure, is illustrated. The circular support member 1210 is semi-circular or a partial arc. In some embodiments, the circular support member 1210 may be half oval. In some embodiments, the circular support member 1210 may include raised vertical sides in tangent with the half circle to provide additional side protection.

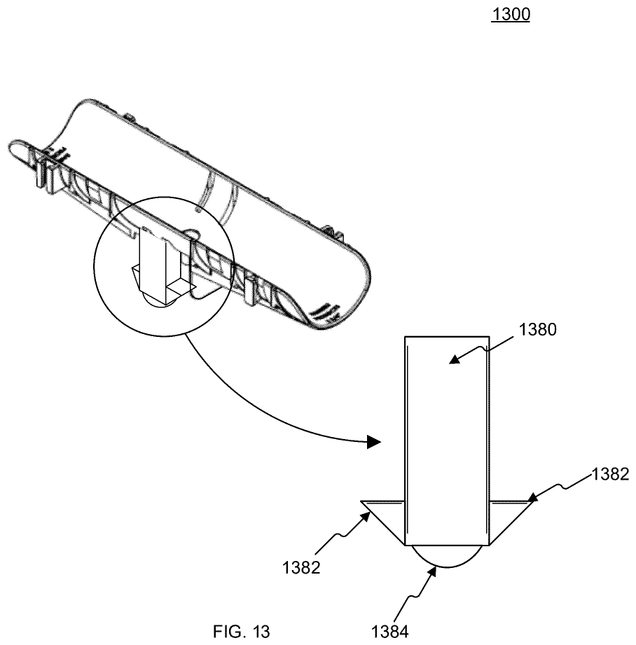

Referring now to FIG. 13, a perspective view of the support saddle 1300 for a pipe, according to some embodiments of the present disclosure, is illustrated. In the support saddle 1300, the plurality of male components is replaced with a spring-loaded bolt 1380. The spring-loaded bolt 1380 includes a plurality of latches 1382. The plurality of latches 1382 are mechanically engaged with one or more springs to provide outward pressure to retain the latches 1382 in place. When engaged with an opening, the springs allow the latches 1382 to retract into the body of the bolt 1380 until the latches clear the edges of the opening to latch into place. The bolt 1380 also includes a release button 1384. When the release button is pressed, the latches 1382 retract into the body of the bolt 1380 and disengage the opening, thereby allow the support saddle 1300 to be removed from its position.

Referring now to FIG. 14, a perspective view of a plurality of support saddles 1400, according to some embodiments of the present disclosure, is illustrated during use. A strut channel 1490 may be provided with a plurality of openings 1492 configured to receive the male components (as discussed previously). When the support saddle 1400 is placed over the openings 1492 and sufficient vertical force is applied, the male components engage the opening and retain the support saddle in place. After the support saddles 1400 are placed in appropriate locations within the strut channel 1490, a pipe 1495 may be placed into the hollow interior of the circular support members of the support saddles.

### Conclusion

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

1. A bracket for supporting a pump, including:
a vertical wall support portion including at least one opening configured for mounting the bracket to a vertical surface;
a horizontal pump support portion extending perpendicularly from the vertical wall support portion, wherein the horizontal pump support portion is configured to receive a pump; and
a continuous raised perimeter wall extending vertically upwardly from a top surface of the horizontal pump support portion at substantially 90 degrees relative to the horizontal pump support portion, wherein the raised perimeter wall and the horizontal pump support portion define a basin configured to collect and contain fluid, wherein the continuous raised perimeter wall forms a watertight enclosure around the horizontal pump support portion without apertures in the perimeter wall.

2. The bracket for supporting a pump of claim 1, wherein the continuous raised perimeter wall creates an incline on an edge of the horizontal pump support portion farthest from the vertical wall support portion.

3. The bracket for supporting a pump of claim 1, wherein the pump is a condensate pump.

4. The bracket for supporting a pump of claim 1, wherein the continuous raised perimeter wall extends along the vertical wall support portion.

5. The bracket for supporting a pump of claim 1, wherein the continuous raised perimeter wall creates a channel on an underside of the bracket, wherein the channel is reinforced to increase a weight holding capacity of the bracket.

6. The bracket for supporting a pump of claim 5, wherein the channel is reinforced using a plurality of ribs.

7. The bracket of claim 1, further including an electronic liquid level detection system integrated into the basin, the detection system configured to activate an alarm upon detection of the liquid reaching a predetermined level.

8. The bracket for supporting a pump of claim 5, wherein the weight holding capacity of the bracket is at least 10 pounds.

9. A bracket assembly for a condensate pump, the bracket assembly including:
a condensate pump; and
a unitary body having a substantially L-shaped profile, the body including:
a horizontal shelf having a top surface for receiving the condensate pump, the condensate pump positioned on the top surface; and
a vertical plate extending upwardly from a rear edge of the horizontal shelf, the vertical plate including a plurality of holes for fastening the bracket assembly to a structure,
wherein the top surface of the horizontal shelf is bounded on at least a front edge and two side edges by an integral, upwardly-projecting wall, the wall thereby forming a basin for pooling liquid on the top surface.

10. The bracket assembly of claim 9, wherein the unitary body further includes a channel on an underside of the unitary body, the channel including a plurality of ribs configured to increase a structural integrity of the bracket.

11. The bracket assembly of claim 9, wherein the upwardly-projecting wall is a continuous raised perimeter wall that extends along the front edge and the two side edges of the horizontal shelf and also extends along at least two vertical side edges and a top edge of the vertical plate.

12. The bracket assembly of claim 9, wherein the unitary body is constructed from a thermoplastic polymer selected from the group including Polyamide (PA), Acrylonitrile Butadiene Styrene (ABS), Polypropylene (PP), Polyvinyl Chloride (PVC), and High-Density Polyethylene (HDPE).

13. The bracket assembly of claim 9, further including a drain port integrated into the basin, the drain port configured to allow for controlled removal of the liquid collected within the basin.

14. The bracket assembly of claim 9, further including an electronic liquid level detection system integrated into the basin, the detection system configured to activate an alarm upon detection of the liquid reaching a predetermined level.

15. A bracket for a condensate pump, including:
a unitary body having a substantially L-shaped profile, the body including:
a horizontal shelf having a top surface for receiving the condensate pump, the horizontal shelf including a front edge and two horizontal side edges;
a vertical plate extending upwardly from a rear edge of the horizontal shelf, the vertical plate including a plurality of holes for fastening the bracket to a structure, and a top edge and two vertical side edges; and
a continuous raised perimeter wall positioned along the edges of the horizontal shelf and the vertical plate, the continuous raised perimeter wall extending vertically from the horizontal shelf and the vertical plate at substantially 90 degrees and forming a watertight basin without apertures,
wherein the continuous raised perimeter wall creates a channel on an underside of the unitary body, wherein the channel is reinforced to increase the carrying capacity of the bracket,
wherein the continuous raised perimeter wall is perpendicular to the horizontal shelf along the front edge and the two horizontal edges, and the continuous raised perimeter wall is perpendicular to the vertical plate along the top edge and the two vertical edges,
wherein the continuous raised perimeter wall forms a basin for pooling liquid on the top surface.

16. The bracket of claim 15, wherein the horizontal shelf is configured to support a plenum-rated condensate pump lacking integral mounting tabs, and wherein the horizontal shelf supports the plenum-rated condensate pump without requiring mounting features on the plenum-rated condensate pump.

17. The bracket of claim 15, wherein the plurality of holes includes at least one keyhole-shaped slot configured to receive a fastener.

18. The bracket of claim 15, further including at least one reinforcement rib disposed within the channel and extending between opposing sides of the continuous raised perimeter wall.

19. The bracket of claim 15, wherein the top surface of the horizontal shelf includes a textured pattern to inhibit movement of the condensate pump.

20. The bracket of claim 16, wherein the bracket is configured to remain fastened to the structure during removal and replacement of a condensate pump from the horizontal shelf.
